(19) United States
(12) Patent Application Publication
(10) Pub. No.: US 2013/0255637 A1
(43) Pub. Date: Oct. 3, 2013

(54) FUEL INJECTOR

(71) Applicants: Tae Sung NOH, Seoul (KR); Kyoung Don LEE, Seoul (KR)

(72) Inventors: Tae Sung NOH, Seoul (KR); Kyoung Don LEE, Seoul (KR)

(73) Assignee: ROBOMECH CO., LTD., Bucheon-si (KR)

(21) Appl. No.: 13/471,761

(22) Filed: May 15, 2012

(30) Foreign Application Priority Data
Mar. 27, 2012 (KR) 10-2012-0031310

(51) Int. Cl. F02M 51/06

(52) U.S. Cl. 123/472

(57) ABSTRACT

A body 600 of a fuel injector 1000 according to the present invention includes: a needle valve mechanism 200 including a needle valve 252 provided near a nozzle portion 250, and a fuel chamber 254; a needle valve actuator 230 mounted with a piston 235 on a center, wherein a spring 240 is disposed into the piston 235; a booster 300 disposed between the needle valve mechanism 200 and a pilot valve 400, and having only a spring-free piston 350; the pilot valve 400 operating by a pressure difference between supplied fuel pressure and working pressure of a solenoid valve 500; and the solenoid valve 500 controlling working pressure of fuel to operate the needle valve actuator 230.

### CROSS-REFERENCE TO RELATED APPLICATION

This application claims the benefit of Korean Patent Application No. 10-2012-0031310, filed on Mar. 27, 2012, in the Korean Intellectual Property Office, the disclosure of which is incorporated herein by reference.

### BACKGROUND OF THE INVENTION

1. Field of the Invention

The present invention relates to a fuel injector, and more particularly, to a fuel injector used for a fuel injection system of an internal combustion engine such as a diesel engine and the like.

2. Description of the Related Art

The fuel injector controls an injection time and an injection amount by operating an oil pressure control solenoid valve or a piezo valve according to a signal transmitted from an electronic control unit (ECU).

An exhaust gas regulation of a diesel engine has been becoming continuously strict. In particular, NOx discharge has been regulated to further decrease in Euro3, Euro4, Euro5, and the like. In order to satisfy the above requirements and to enhance an exhaust gas characteristic, it is advantageous to decrease an injection rate during an injection delay and to increase an injection rate after combustion is initiated using an injection characteristic of the fuel injector. Also, injection needs to be performed by dividing a single injection cycle into a plurality of injections such as a pre-injection, a main-injection, a post-injection, and the like, and the pressure of pre-injection and the pressure of main-injection need to be adjusted to be different from each other.

A related art includes a pilot control spring disposed between an upper end of a valve piston and an internal upper end surface of a valve control chamber within the valve control chamber to downwardly and elastically support the valve piston, and a needle guide downwardly supported by a needle spring to guide a connector of a nozzle needle within a needle space and formed with a constraint groove with a depth corresponding to a lifting section on a lower end surface of the valve control chamber to constantly constrain the lifting section of the nozzle needle during pilot injection.

However, the related art has a problem that it is difficult to clearly generate two-phase pressure during the main injection. Also, while injection is not being performed, the inside of a fuel injector is maintained at low pressure and thus, a time is delayed until high pressure for injection occurs. Accordingly, injection is slowed down whereby an injection characteristic is degraded.

### SUMMARY OF THE INVENTION

An aspect of the present invention provides a fuel injector that may adjust injection pressure of a fuel injector using two phases and thereby decrease an injection rate when the injection is being delayed and may increase the injection rate when the injection is initiated, thereby enhancing an exhaust gas characteristic of a diesel engine.

Another aspect of the present invention also provides a fuel injector that may optimally control a time and an amount of fuel injection by applying a pilot valve.

Another aspect of the present invention also provides a fuel injector that may enhance the durability of a booster by applying a spring-free booster and may also effectively control an injector.

According to an aspect of the present invention, there is provided a body of a fuel injector including: a needle valve mechanism including a needle valve provided near a nozzle portion, and a fuel chamber; a needle valve actuator mounted with a piston on a center, wherein a spring is disposed into the piston; a booster having only a spring-free piston; a pilot valve operating by a pressure difference between supplied fuel pressure and working pressure of a solenoid valve; and the solenoid valve controlling working pressure of fuel to operate the needle valve actuator or the pilot valve. First through third chambers may be formed in an upper portion, a middle portion, and a lower portion, respectively, based on the piston.

According to another aspect of the present invention, there is provided a body of a fuel injector including: a needle valve mechanism including a needle valve provided near a nozzle portion, and a fuel chamber; a needle valve actuator including a piston, wherein a spring is disposed into the piston; a booster having only a spring-free piston; a pilot valve operating by a pressure difference between supplied fuel pressure and working pressure of a solenoid valve; and the solenoid valve controlling working pressure of fuel to operate the needle valve actuator or the pilot valve and having a solenoid valve chamber. A third orifice is mounted on one side of the booster to be capable of adjusting pressure of supplied fuel, and a fourth orifice is mounted on a fuel passage formed between the booster and the needle valve actuator. In the pilot valve, a fifth orifice for adjusting pressure of fuel is mounted on one side of the spacer.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a view schematically illustrating a fuel injection apparatus of a diesel engine;

FIGS. 2 through 5 are cross-sectional views step by step illustrating a low pressure mode of a fuel injector from an initial state of the fuel injector according to an embodiment of the present invention;

FIGS. 6 and 7 are cross-sectional views step by step illustrating a high pressure mode of a fuel injector according to an embodiment of the present invention;

FIG. 8 is a cross-sectional view illustrating a state in which a mode of a fuel injector is switched from a high pressure mode to an initial mode according to an embodiment of the present invention;

FIGS. 9A and 9B are views illustrating a change in pressure and a pressure state of a conventional booster;

FIGS. 10A and 10B are views illustrating a change in pressure and a pressure state of a booster that is a major component of the present invention; and

FIG. 11 is a cross-sectional view illustrating a fuel injector according to another embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a fuel injector according to an embodiment of the present invention will be described with reference to the accompanying drawings.

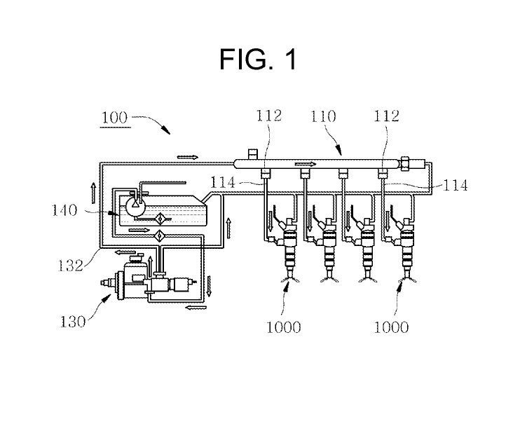

As shown in FIG. 1, a fuel injection apparatus 100 used for a diesel engine includes a common rail 110 storing pressurized fuel, a fuel injector 1000 mounted to each cylinder of an engine (not shown), a supply pump 130 pressurizing fuel and supplying the pressurized fuel to the common rail 110, and a fuel tank 140 connected to the common rail 110 and the supply pump 130.

The common rail 110 and the supply pump 130 are connected to each other by a fuel supply pipe 132. A discharge amount of the supply pump 130 is configured to be controlled by a control unit (not shown), for example, an electronic control unit (ECU) so that fuel pressure of the common rail 110 may become a desired value or zero.

A plurality of discharge ports 112 is formed on the common rail 110 to supply fuel to the fuel injector 1000 of each cylinder. In FIG. 1, the fuel injector 1000 of each cylinder is connected to each of the discharge ports 110 formed on the common rail 110 through a fuel supply passage 114. Through this configuration, fuel may be supplied to each fuel injector 1000.

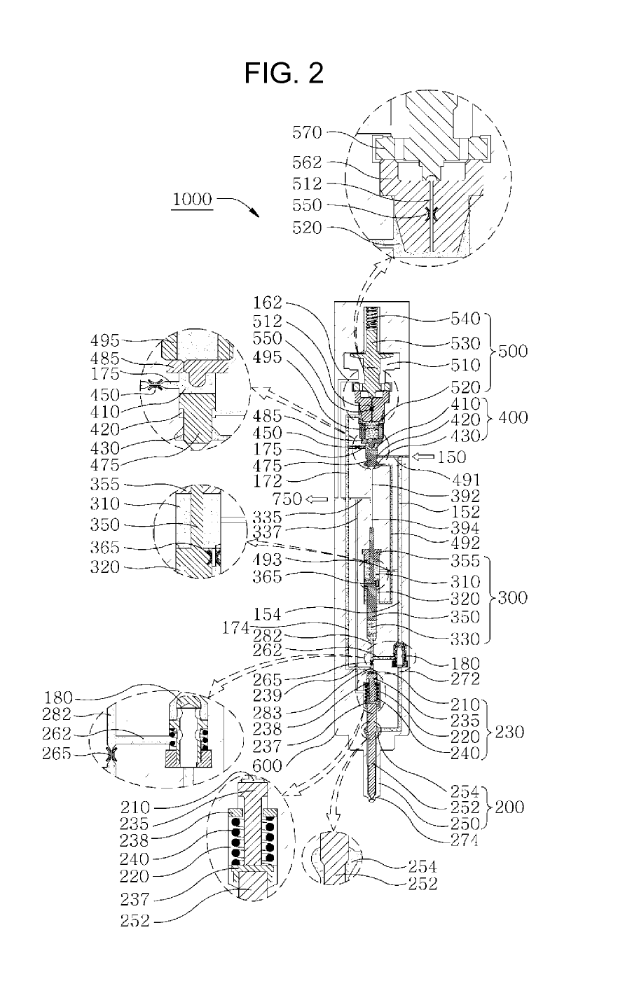

As shown in FIG. 2, a body 600 of the fuel injector 1000 includes a needle valve mechanism 200, a needle valve actuator 230, a booster 300, a pilot valve 400, and a solenoid valve 500.

The body 600 may further include a fuel inlet 150 and a fuel returning portion 750 that are connected to fuel passages, which will be described later. A check valve 180 is mounted on one side of a fuel passage 150 continuing to the fuel inlet 150.

As shown in FIGS. 1 and 2, the fuel inlet 150 is connected from the common rail 110 through the fuel supply passage 114 and supplies fuel from the common rail 110 to a fuel chamber 254 through the fuel passage 152 and through a fuel passage 272 formed between the check valve 180 and a nozzle portion 250. A fuel injection hole 274 is formed in an end of the nozzle portion 250 to be capable of injecting the supplied fuel.

The check valve 180 is mutually connected with the fuel passage 272 connected to the fuel chamber 254 and a fuel passage 262 that mutually continues to fuel passages 282 and 283.

The needle valve mechanism 200 includes a needle valve 252, which is provided near the nozzle portion 250, and the fuel chamber 254. The needle valve actuator 230 is mounted above the needle valve 252 to operate the needle valve 252. A piston 235 is mounted on a center of the needle valve actuator 230. A spring 240 is disposed into the piston 235. In the needle valve actuator 230, a spacer spring 238 is mounted on one side of the piston 235 and a shim 237 is mounted on another side of the piston 235. The spring 240 is disposed between the spacer spring 238 and the shim 237. Also, a first chamber 210 is formed above the piston 235, and a second chamber 220 is formed in the spring 240 side formed in the middle of the piston 235. The needle valve actuator 230 and the solenoid valve 500 to be described later are configured to be mutually connected to each other by the fuel passages 172 and 174.

Even though the booster 300 may be installed between the needle valve mechanism 200 and the solenoid valve 500, an example in which the booster 300 is disposed between the needle valve mechanism 200 and the pilot valve 400 as shown in FIG. 2 will be described as an example.

The booster 300 includes the piston 350 in a shape of a cross, and does not employ a spring, which is different from a conventional booster.

The booster 300 corresponding to a main component of the present invention is formed with first through third chambers 310, 320, and 330 in an upper portion, a middle portion, and a lower portion, respectively, based on the piston 350. The piston 350 of the booster 300 is configured to be spring free and be controllable according to pressure of fuel. Also, in the booster 300, a sleeve stone 355 is mounted on one side of the piston 350. A third orifice 365 is mounted on one side of the booster 300 to be capable of adjusting the pressure of supplied fuel.

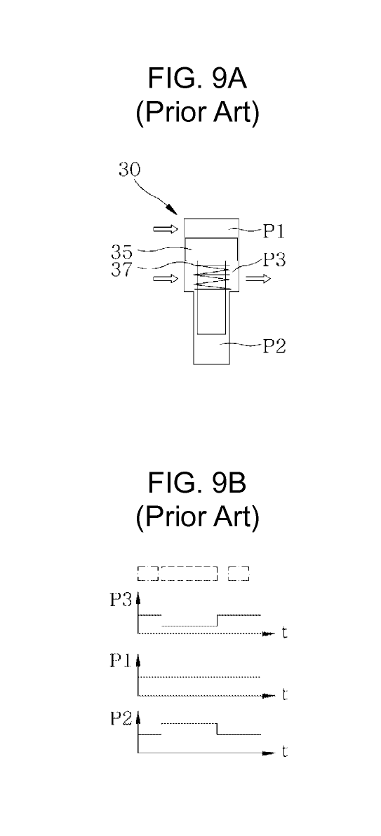

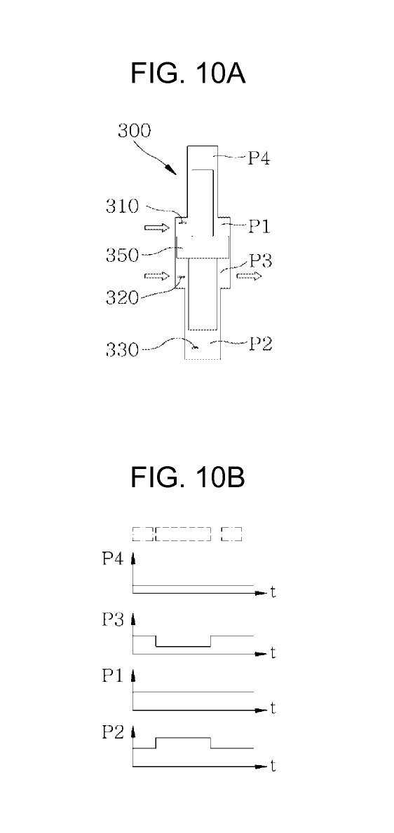

As shown in FIG. 9A, a conventional booster 30 includes a piston 35 and a spring 37 mounted on one side below the piston 35. As shown in FIG. 10A, the booster 300 of the present invention includes the piston 350 in the shape of a cross, for example, in a form of three blocks, and the sleeve piston 355. Hereinafter, a change in pressure to a time between the conventional booster 35 and the booster 300 of the present invention will be described. As shown in FIG. 9B, when it is assumed that upper pressure of the piston 35 is P1, pressure of the spring 37 side is P3, and lower pressure of the piston 35 is P2 in the conventional booster 30, normal pressure of the conventional booster 30 is calculated according to P1=P2+P3+Fspring. That is, the lower pressure of the piston P2 is calculated according to P2=(P1*A1−P3*(A1−A2)−Fspring)/A2. A change in the pressure of the conventional booster 30 is shown in FIG. 9B. In a time-to-pressure graph, high-pressure (boosting) injection is performed in the case of P2.

However, as shown in FIG. 10A, when it is assumed that upper pressure of the piston 350 is P4, pressure of the first chamber 310 side is P1, pressure of the second chamber 320 side is P3, and pressure of the third chamber 330 side is P2, pressure of the booster 300 is calculated according to P2=(P1*(A1−A4)+P4*A4−P3*(A1−A2))/A2. Accordingly, A2=P1/P2*(A1−A4)+P4/P2*A4−P3/P2*(A1−A2).

Here, A1-A4 denote an area where P1 works, A2 denotes an area where P2 works, A1-A2 denotes an area where P3 works, and A4 denotes an area where P4 works. For reference, P1 denotes common rail pressure and P4 denotes return pressure.

Accordingly, unlike the conventional booster 30, the booster 300 of the present invention may perform high pressure boosting without employing a spring. Also, as shown in FIG. 10B, the booster 300 of the present invention performs high pressure (boosting) injection in the case of P2 in a time-to-pressure graph. That is, in the pressure P2 graph, when pressure is high, it indicates a high pressure (boosting) injection mode, and when pressure decreases after the high pressure injection mode, it indicates a return mode.

For reference, in FIG. 9B and FIG. 10, a square indicated by a single-point chain line indicates a low pressure injection and a square indicated by a dotted line indicates a high pressure injection.

The third orifice 365 is mounted on one side of the booster 300 to be capable of adjusting pressure of supplied fuel. The fourth orifice 265 is mounted on one side of fuel passages 282 and 283 formed between the booster 300 and the needle valve actuator 230. The fourth orifice 265 is able to adjust the pressure of fuel between the fuel passages 262 and 282 and the fuel passages 172 and 174.

Meanwhile, the booster 300 and the pilot valve 400 are mutually connected to each other by fuel passages 392, 394, and 492 and are also mutually connected to each other by fuel passages 491, 493, and 262 connected to the fuel passage 152.

As shown in FIG. 2, the pilot valve 400 includes a spool 475, a spacer 485 mounted above the spool 475, and a plug 495 mounted above the spacer 485. The pilot valve 400 operates by a pressure difference between supplied fuel pressure and working pressure of the solenoid valve 500. The pilot valve 400 includes the first through third chambers 410, 420, and 430, and the second orifice 450 is mounted on one side of the pilot valve 400.

The second orifice 450 is mounted on one side of the first chamber 410 and is mounted on one side of a fuel passage 175 continuing to the fuel passage 172. The fuel passage 172 continues to the solenoid valve chamber 520 of the solenoid valve 500 to be described later and to the fuel passage 239 of the needle valve actuator 230 side. Also, the second orifice 450 is configured to control low pressure generated by the fourth orifice 265 and separate pressure at a predetermined time interval using the low pressure.

The pilot valve 400 may also decrease pressure in the second chamber 320 of the booster 300. The pilot valve 400 operates by a pressure difference between the supplied fuel pressure and the working pressure of the solenoid valve 500.

One side of a fuel passage 335 formed between the fuel passages 392 and 394 that are formed below the spool 475 of the pilot valve is connected to the fuel returning portion 750 side, and another side of the fuel passage 335 is connected to a fuel passage 337 that is connected to the needle valve actuator 230 side.

The solenoid valve 500 controls working pressure of fuel that is used to control the needle valve actuator 230 or the pilot valve 400. The solenoid valve 500 includes a plunger 530 and a spring 540 mounted above the plunger 530.

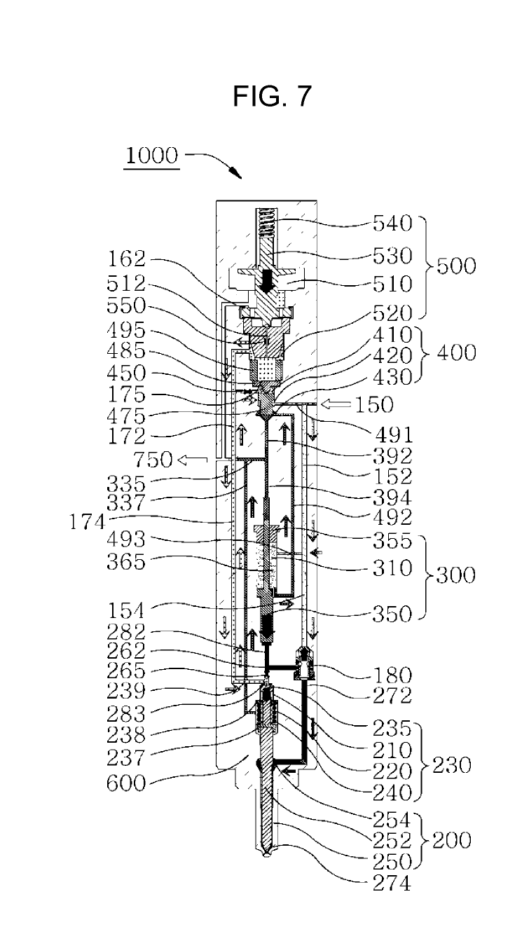

Even though not illustrated, the solenoid valve 500 further includes an electronic valve operating the solenoid valve 500. In FIG. 7, a not-described reference numeral 570 indicates a solenoid spacer. Also, the solenoid valve 500 includes a returning chamber 510 for returning fuel, and a first orifice 550 is mounted to a fuel passage 512 formed below a solenoid body 562. The returning chamber 510 is connected to a fuel returning portion 750 through a fuel passage 162. The first orifice 550 controls a predetermined amount of fuel to pass after the solenoid valve 500 is operated.

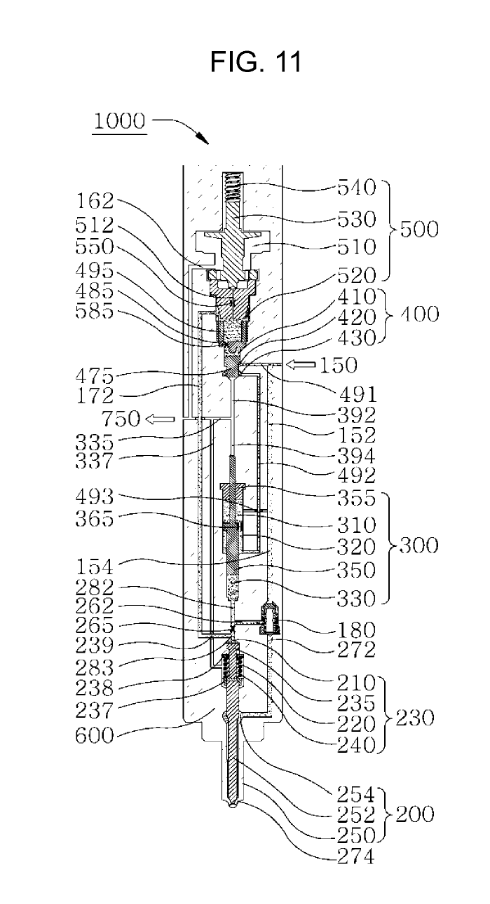

Meanwhile, as shown in FIG. 11, a fuel injector according to another embodiment of the present invention has the overall similar configuration to the aforementioned embodiment. Only difference is that the second orifice 450 mounted to the fuel passage 175 in the aforementioned embodiment is not applied. That is, in the fuel injector according to another embodiment of the present invention, a fifth orifice 585 for adjusting pressure of fuel is mounted on one side of the spacer 485 instead of employing the second orifice 450.

Hereinafter, operations of the fuel injector according to embodiments of the present invention constructed as above will be described with reference to the accompanying drawings.

As shown in FIG. 1, in the fuel injection apparatus 100, an engine (not shown) rotates to thereby drive the supply pump 130. Through this, fuel inhaled from the fuel tank 140 to the supply pump 130 is pressurized and then is supplied to the common rail 110.

Based on an operation state of the engine, pressure of fuel induced from the supply pump 130 is adjusted by a control unit (not shown) and the fuel pressurized at predetermined pressure is accumulated in the common rail 110.

In a combustion chamber (not shown) of each cylinder of the engine, fuel is injected from the fuel injection hole 274 of each injection injector 1000. Based on an operation circumstance of the engine, the fuel injector 1000 drives the fuel at low pressure or high pressure. For example, when the engine is driven at high load, the fuel injector 1000 drives the fuel in a high pressure mode. When the engine is driven idly, that is, when the engine is driven at low load, the fuel injector 1000 drives the fuel in a low pressure mode.

As shown in FIGS. 1 and 2, in an initial state of the fuel injector 1000, fuel provided through the fuel passage 114 is supplied to the fuel passages 152, 154, and 272, and the fuel passages 172, 174, 175, and 239 at nearly constant pressure through the fuel inlet 150. The fuel is also supplied to the fuel chamber 254 at predetermined pressure.

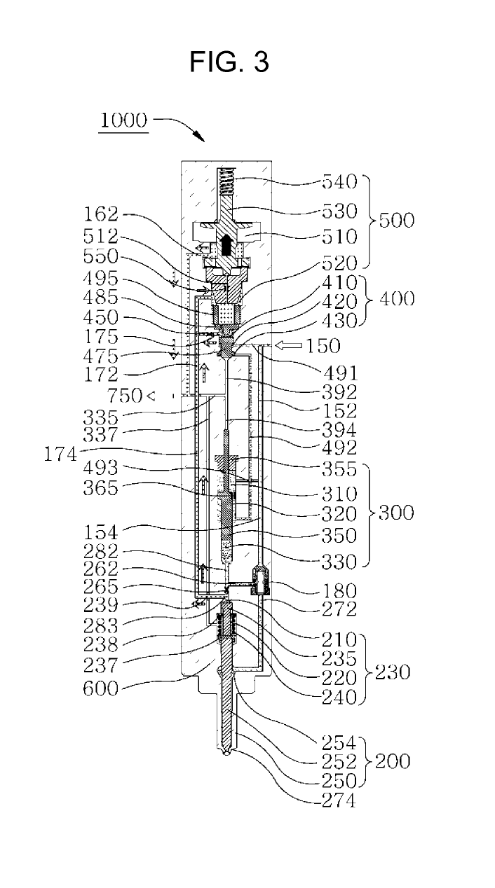

When the solenoid valve 500 operates in an initial state as shown in FIG. 2 to thereby open the plunger 530 as shown in FIG. 3, fuel is returned to the fuel tank 140 through the fuel returning portion 750 and the pressure becomes zero. Therefore, the fuel injector 1000 is maintained in an initial low pressure mode. That is, when the plunger 530 is opened, the fuel moves along an arrow indicator direction through the fuel passages 172 and 74 continuing to the needle valve actuator 230 side and thereby moves to the solenoid valve chamber 520. The fuel is discharged from the solenoid valve chamber 520 to the fuel returning portion 750 through the first orifice 550 mounted to the fuel passage 512 and through the fuel passage 162.

Even though the first orifice 550 and the fourth orifice 265 are opened in the initial low pressure mode of the fuel injector 1000, the second orifice 450 may be controlled to be closed or be maintained in a slightly open state. That is, this is to possibly decrease the affect of the second orifice 450 with respect to the pressure of fuel of the fuel passage 172.

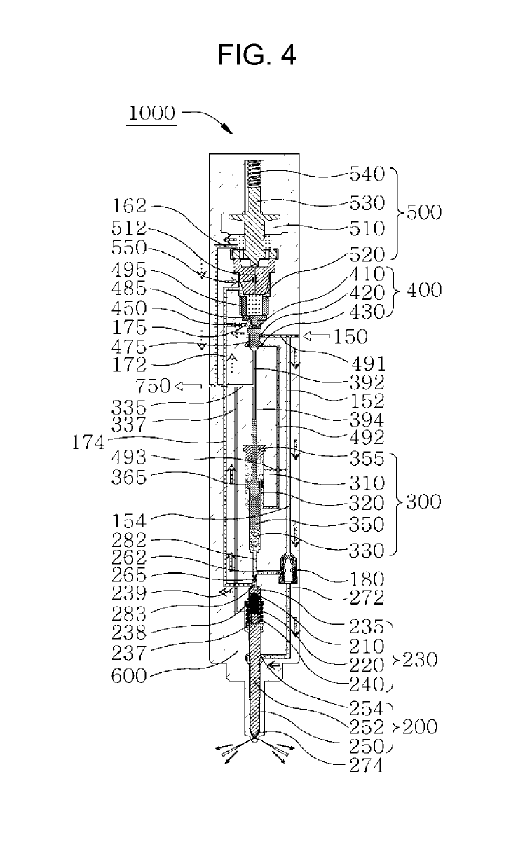

In the above state, the needle valve actuator 230 performs low pressure injection while upwardly moving due to an increase in the pressure of the fuel chamber 254, as shown in FIG. 4. When the piston 235 of the needle valve actuator 230 is upwardly moved, the fuel moves to the solenoid valve chamber 520 of the solenoid valve 500 side through the fuel passages 172 and 174, and is discharged to the fuel returning portion 750 through the first orifice 550 and through the fuel passage 162. The fuel moves from the fuel inlet 150 to the fuel chamber 254 through the fuel passages 152 and 154, through the check valve 180, and passing by the fuel passage 272, and is injected via the fuel injection hole 274.

In the fuel injector 1000, fuel provided from the fuel inlet 150 passes through the fuel chamber 254 and the needle valve actuator 230. Here, a portion of fuel moves to the fuel passage 335 through the fuel passage 337 mounted on one side of the needle valve actuator 230, and another portion of fuel moves to the solenoid valve chamber 520 through the fuel passages 230, 172, and 174 mounted above the needle valve actuator 230. The moved fuel moves to the fuel tank 40 through the fuel returning portion 750.

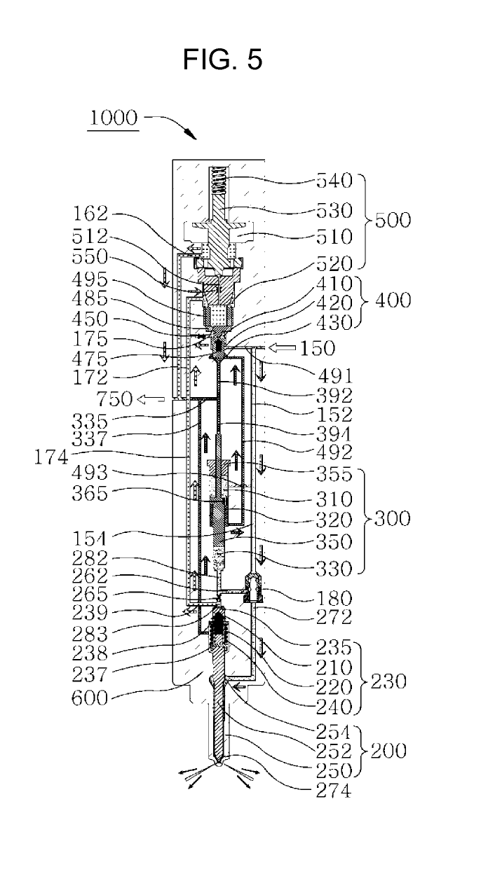

In the above state, as shown in FIG. 5, when fuel of the fuel passage 175 moves from the first chamber 410 of the pilot valve 400 through the second orifice 450 mounted to the fuel passage 175, the first chamber 410 enters in a lower pressure state than the second chamber 420. Here, due to the pressure difference, the pilot valve 400 escalates and the fuel is discharged to the fuel returning portion 750 through the fuel passage 492 connected to the second chamber 320 of the booster 300 and through the third chamber 430 of the pilot valve 400 to thereby decrease the pressure in the second chamber 320 of the booster 300.

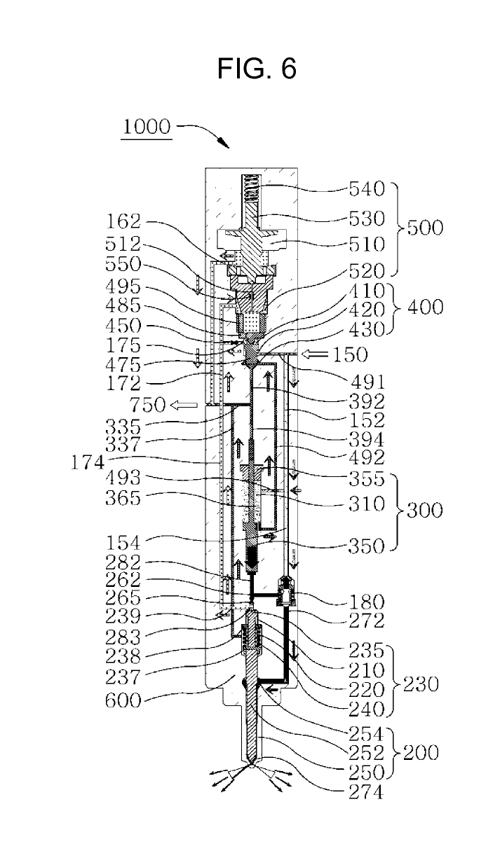

Meanwhile, FIGS. 6 and 7 are cross-sectional views illustrating an example in which the fuel injector 1000 performs high pressure injection.

When the pressure decreases in the second chamber 320 of the booster 300, the pressure of the first chamber 310 of the booster 300 increases to be greater than the pressure of the third chamber 330 and thus, the third chamber 330 is pressurized due to the above pressure difference. In this instance, the pressure of the fuel passages 282 and 262 increases to be greater than the pressure of the fuel passage 152. Accordingly, the fuel does not move to the fuel passage 152 side by the check valve 180 and moves to the fuel chamber 5 through the fuel passage 272. The fuel moved to the fuel chamber 254 is injected at the high pressure through the nozzle portion 250 and through the fuel injection hole 274.

When an operation of the solenoid valve 500 is switched off after the high pressure injection, the plunger 530 is closed as shown in FIG. 7. When the plunger 530 is closed, the remaining fuel moves to the needle valve actuator 230 through the fuel passages 172, 174, and 239. The moved fuel increases the pressure of the needle valve actuator 230 to thereby decrease the pressure of the needle valve 252. Here, the needle valve 252 closes the fuel injection hole 27 and thus, the fuel injection is suspended.

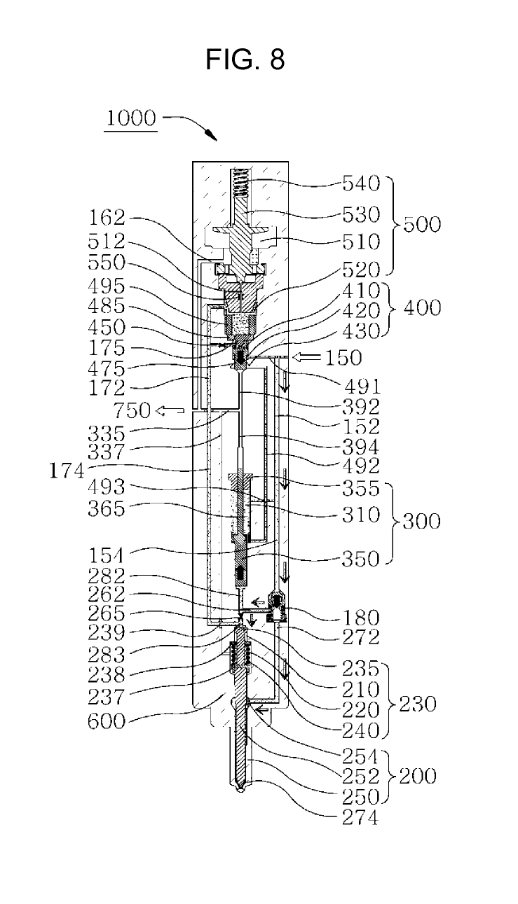

In the above state, as shown in FIG. 8, the pilot valve 400 moves down whereby the fuel supplied to the fuel passage 493 fills in the second chamber 320 of the booster 300 through the first chamber 310 of the booster 300 and through the third orifice 365. Also, a portion of fuel supplied through the fuel inlet 150 elevates the piston 350 of the booster 300 while downwardly pushing the check valve 180 through the fuel passage 152. Another portion of the supplied fuel moves to the fuel chamber 254 through the fuel passage 272.

Meanwhile, in the fuel injector 1000 according to another embodiment of the present invention, when the solenoid valve 500 operates, the needle valve mechanism 200 escalates and fuel of the first chamber 410 of the pilot valve 400 is discharged through the fifth orifice 585. The fuel discharged through the fifth orifice 585 is discharged to the fuel returning unit 750 through the fuel passage 162.

When releasing the solenoid valve 500, fuel is returned to the first chamber 410 of the pilot valve 400 through the fifth orifice 585 mounted on one side of the spacer 485, instead of the second orifice 450, which is different from the aforementioned embodiment. The remaining operation is the same as the aforementioned embodiment and thus, further detailed description will be omitted here.

A fuel injector according to embodiments of the present invention constructed as above may perform two-phase injection including a high pressure injection and a low pressure injection by applying a piston-free booster and thus, may optimally control a time and an amount of fuel injection.

Also, a fuel injector according to embodiments of the present invention may optimally control a time and an amount of fuel injection by enabling a pilot valve, that is, a differential pilot valve to control a booster. In addition, by applying a spring-free booster, a lifespan of the injection may be extended. Constant pressure may be supplied from the booster and thus, it is possible to decrease exhaust gas and an environmental pollution.

Also, an injection injector according to embodiments of the present invention may be widely applicable to the field of a fuel injection apparatus of a vehicle engine.

Also, a fuel injector according to embodiments of the present invention may optimally control a time and an amount of fuel injection by enabling a pilot valve, that is, a differential pilot valve, to control a booster.

Also, a fuel injector according to embodiments the present invention may extend a lifespan of the injector by applying a spring-free booster and enables constant pressure to be supplied from the booster. Accordingly, exhaust gas may decrease, which may result in decreasing environmental pollution.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A fuel injector for injecting fuel into combustion chambers of an internal combustion engine, wherein a body of the fuel injector comprises:
a needle valve mechanism including a needle valve, which is provided near a nozzle portion, and a fuel chamber;
a needle valve actuator having a piston into which a spring is disposed;
a booster formed with first through third chambers in an upper portion, a middle portion, and a lower portion, respectively, based on a piston, and having the spring-free piston;
a pilot valve operating by a pressure difference between supplied fuel pressure and working pressure of a solenoid valve, and having a spool and a spacer mounted above the spool; and
a solenoid valve controlling working pressure of fuel to operate the needle valve actuator or the pilot valve.

2. The fuel injector of claim 1, wherein the body of the fuel injector further comprises a fuel inlet and a fuel returning portions that are connected to fuel passages,
fuel flowing from the fuel inlet continues to a fuel passage of which one side continues to fuel passages and another side continues to the spool, and a check valve is mounted on one side of the fuel passages, and the check valve is mutually connected to a fuel passage 262 mutually continuing with fuel passages 282 and 283 and to a fuel passage 272 connected to the fuel chamber.

3. The fuel injector of claim 1, wherein, in the needle valve actuator, a spacer spring is mounted on one side of the piston, a shim is mounted on another side of the piston, and the spring is disposed between the spacer spring and the shim.

4. The fuel injector of claim 1, wherein the needle valve actuator is formed with first and second chambers, and the first chamber is formed above the piston, and the second chamber is formed on the spring side.

5. The fuel injector of claim 1, wherein, in the booster, a sleeve piston is mounted on one side of the piston.

6. The fuel injector of claim 1, wherein a third orifice is mounted on one side of the booster to be capable of adjusting the pressure of supplied fuel.

7. The fuel injector of claim 1, wherein the pilot valve further comprises a plug mounted above the spacer, and is formed with first through third chambers between the spool and the spacer.

8. The fuel injector of claim 1, wherein, in the pilot valve, a second orifice is mounted on one side of a fuel passage formed in a first chamber.

9. The fuel injector of claim 1, wherein the solenoid valve includes a returning chamber for returning fuel, a solenoid valve chamber, and a plunger, and a first orifice is mounted to a fuel passage formed below the plunger.

10. The fuel injector of claim 1, wherein fuel passages are formed between the booster and the needle valve actuator, and a fourth orifice is mounted on one side of the fuel passages.

11. A fuel injector for injecting fuel into combustion chambers of an internal combustion engine, wherein a body of the fuel injector comprises:
a needle valve mechanism including a needle valve, which is provided near a nozzle portion, and a fuel chamber;
a needle valve actuator mounted with a piston on a center, wherein a spring is disposed into the piston;
a booster disposed between the needle valve mechanism and a pilot valve, and having a spring-free piston;
the pilot valve operating by a pressure difference between supplied fuel pressure and working pressure of a solenoid valve; and
the solenoid valve controlling working pressure of fuel to operate the needle valve actuator or the pilot valve, and having a solenoid valve chamber,
wherein a third orifice is mounted on one side of the booster to be capable of adjusting the pressure of supplied fuel, and a fourth orifice is mounted on fuel passages and formed between the booster and the needle valve actuator, and
said pilot valve has a fifth orifice mounted on one side of a spacer in order to adjust pressure of fuel.

12. The fuel injector of claim 11, wherein the solenoid valve includes a returning chamber for returning fuel, and a first orifice is mounted to a fuel passage formed below the returning chamber.

13. The fuel injector of claim 11, wherein the pilot valve includes a spool, the spacer mounted above the spool, and a plug mounted above the spacer.

14. The fuel injector of claim 13, wherein a second chamber and a third chamber are formed on one side of the spool of the pilot valve at a predetermined interval, and the second chamber continues to fuel passages continuing to the fuel inlet, and the third chamber mutually continues with a second chamber of the booster by a fuel passage.

15. The fuel injector of claim 11, wherein the booster is formed with first through third chambers in an upper portion, a middle portion, and a lower portion, respectively, based on a piston, and the piston of the booster is configured to be spring-free and controllable according to pressure of fuel.

16. A fuel injector for injecting fuel into combustion chambers of an internal combustion engine, wherein a body of the fuel injector comprises:
a needle valve mechanism including a needle valve provided near a nozzle portion, and a fuel chamber;
a needle valve actuator mounted with a fourth orifice in a rear end of the needle valve actuator, and having a piston into which a spring is disposed;
a booster mounted with a third orifice on one side of the booster and having a spring-free piston;
a pilot valve operating by a pressure difference between supplied fuel pressure and working pressure of a solenoid valve, and having a spacer mounted above the spool; and
a solenoid valve controlling working pressure of fuel to operate the needle valve actuator or the pilot valve,
wherein the pilot valve includes a second orifice that is mounted on a fuel passage continuing to a first chamber of the pilot valve or a fifth orifice that is mounted on the spacer.

17. The fuel injector of claim 16, wherein the fourth orifice adjusts pressure of fuel between fuel passages 262 and 282 and fuel passages 172 and 174, and the second orifice controls low pressure generated by the fourth orifice and separate pressure at a predetermined time interval using the low pressure.

18. The fuel injector of claim 16, wherein the booster is formed with first through third chambers in an upper portion, a middle portion, and a lower portion, respectively, based on a piston, and a sleeve piston is mounted above the first chamber.

19. The fuel injector of claim 16, wherein the pilot valve further includes a plug mounted above the spacer, and is formed with first through third chambers between the spool and the spacer.

20. The fuel injector of claim 16, wherein the solenoid valve includes a returning chamber for returning fuel, and a first orifice is mounted to a fuel passage formed below the returning chamber.
